(19) United States
(12) Patent Application Publication
(10) Pub. No.: US 2016/0141827 A1
(43) Pub. Date: May 19, 2016

(54) Solid State Laser System

(71) Applicant: PROTON LASER APPLICATIONS, S.L., Salamanca (ES)

(72) Inventor: Miguel Galan Valiente, Salamanca (ES)

(21) Appl. No.: 14/890,314

(22) PCT Filed: May 12, 2014
(86) PCT No.: PCT/EP2014/059661

§ 371 Date: Nov. 10, 2015

(30) Foreign Application Priority Data
May 10, 2013 (EP) 13167241.2

(51) Int. Cl. H01S 3/08; H01S 3/0941; H01S 3/16; H01S 3/094

(52) U.S. Cl. CPC H01S 3/08072; H01S 3/094076; H01S 3/094084; H01S 3/0941; H01S 3/1643; H01S 3/1653

(57) ABSTRACT

A laser system comprising an active medium (105) and at least one laser diode (103) that is adapted to pump the active medium, characterized in that the laser diode is arranged such that a radiation plane of laser radiation emitted from the laser diode and corresponding to the greatest emission angle a is essentially parallel or oblique to a longitudinal axis (L) of the active medium (105). The pump LD array is arranged with the long axis of each LD being parallel to the longitudinal axis (L) of the active medium (105). A laser system comprising an active medium and a reflector (530) being arranged such that the reflector surrounds the active medium (505) with at distance to the active medium characterized in that the reflector comprises a self-supporting cylinder consisting at least in part of a metal, e.g. copper, and a method for pumping an active medium of a Q-switch laser system with a plurality of laser diodes, the method being characterized in that the active medium is pumped continuously during pumping periods of a predetermined duration, the pumping periods being provided periodically and being separated by non-pumping periods, wherein, during each pumping period, at least two laser pulses are emitted from the active medium, wherein each of the at least two laser pulses is caused by a corresponding Q-switch operation in the pumping period.

The present invention relates to a solid state laser system.

### PRIOR ART

Solid state laser systems are well known in the art. Among them, laser systems comprising an active medium which is pumped by further laser diodes, thereby achieving a higher output energy of the active medium, are commonly known. The laser diodes comprise a relatively high efficiency. Such laser systems are used in a pulsed mode in order to achieve high power in the short pulses.

Further, systems for generating laser pulses having short or very short durations within the range of several 10 nanoseconds are known in the art. For example, in “large volume TEM₀₀ mode operation of Nd:YAG lasers” by D C Hanna et al., a laser system including a resonator incorporating a suitable adjusted telescope is discloses, which allows for emitting large volume TEM₀₀ modes.

Still further, “high power, single frequency operation of a Q-switched TEM₀₀ mode Nd:YAG laser” by A. J. Berry et al., shows another Q-switched Nd:YAG laser using a telescopic resonator configuration in order to produce single longitudinal modes.

The known laser systems suffer from a variety of drawbacks that influence the special shape of the TEM₀₀ mode that is to be emitted within the laser pulse. This is because, for example through thermal stress in the active medium and the optical systems, it is difficult to separate only one single frequency in order to generate the TEM₀₀ mode. Therefore, other frequencies contribute to the generated laser pulse, which becomes even more relevant the shorter the laser pulse is, and, therefore, a single longitudinal mode TEM₀₀ pulse cannot reliably be generated.

### Technical Problem

Starting from known solid state laser systems, it is an object of the present invention to provide a more efficient laser system in view of the exploitation of the radiation being emitted by the laser diodes for pumping the active medium and to increase the efficiency factor of the laser system with respect to the energy being emitted by the active medium and the corresponding amount of energy that is necessary to pump the active medium, and, further, to provide a laser system that can generate TEM₀₀ laser pulses with improved pulse quality.

### Solution

This problem is solved by the laser system according to independent claim 1 and the method for generating laser pulses according to independent claim 12 and the laser system according to claim 22, as well as the method for pumping an active medium of a laser system according to claim 26 and the laser system according to claim 30.

The laser system according to the present disclosure comprises an active medium and at least 1, 5, 20, or 25 laser diode(s) that is/are adapted to pump the active medium, and is characterized in that the laser diode(s) is/are arranged such that a radiation plane of laser radiation emitted from the laser diode(s) and corresponding to the greatest emission angle α is essentially parallel or oblique to a longitudinal axis of the active medium. By arranging the laser diodes accordingly, the number of necessary laser diodes can be reduced and the energy being emitted from these laser diodes can be used more efficiently.

According to one embodiment, the laser system further comprises one or more blocks surrounding the active medium, wherein each of the blocks comprises a plurality of laser diodes, wherein each of the laser diodes is arranged such that the radiation plane of laser radiation emitted from the laser diode and corresponding to the greatest emission angle α is essentially parallel to the longitudinal axis of the active medium. In this embodiment, the advantage of positioning a plurality of laser diodes in accordance with the first embodiment is provided.

In accordance with this, optionally, the laser diodes are arranged, in at least one block, with a distance d to each other and the block being arranged in a distance h from the active medium, wherein the distance h is given by

$$h \geq tan ( \frac{π}{2} - \frac{α}{2} ) \cdot \frac{d}{2} .$$

Such an arrangement allows for utilizing the overlap of adjacent laser diodes, and the radiation emitted by these laser diodes respectively, to pump the active medium more efficiently and/or more homogeneously.

According to another embodiment, the laser system is characterized in that the laser diodes of each block are arranged on a straight line being parallel to the longitudinal axis of the active medium. This allows for providing a more homogeneous radiation field of the pumping radiation.

Further, it can be provided that the blocks are arranged in an angular distance to each other, the angle being measured around the centre of the active medium in a plane perpendicular to a longitudinal axis of the active medium, wherein the angular distance of two adjacent blocks is

$$\frac{2 π}{n} ,$$

where n is the number of blocks. Thereby an angular homogeneity with respect to the pumping radiation is achieved.

According to yet another embodiment, the laser system further comprises a reflector being arranged between the active medium and the laser diode and surrounding the active medium and comprising portions that are transparent for the radiation that can be emitted by the laser diode, wherein the reflector is formed such that radiation that can be emitted from the laser diode and can pass through the active medium via at least one of the portions can be reflected onto the active medium. Correspondingly, radiation being emitted from the laser diodes and passing through the portions and the active medium can be reflected onto the active medium again, thereby increasing the amount that is absorbed by the active medium, thereby increasing the pumping efficiency.

In order to solve the above problem, a laser system is provided that comprises an active medium and a reflector being arranged such that the reflector surrounds the active medium with at distance to the active medium characterized in that the reflector comprises a self-supporting cylinder consisting at least in part of a metal, e.g. copper. By providing a corresponding cylinder, the thermal conduction of heat generated in the active medium can be improved and, further, providing quartz cylinders with a coated surface in order to reflect radiation can be avoided, thereby simplifying manufacturing processes and/or increasing the heat resistance of the reflector.

The system may be further characterized in that the reflector further comprises a quartz-cylinder, wherein the quartz-cylinder and the copper-cylinder are joint together. Thereby, the advantages of the provided metal cylinder and a quartz cylinder can be combined.

According to one embodiment, that the laser system further includes laser diodes being arranged outside of the reflector, wherein the reflector comprises portions being transparent for laser radiation that is emitted from the laser diodes and that are arranged such that, when the laser diodes emit laser radiation, the laser radiation can incite, through the portions, onto the active medium. Thereby, radiation that is emitted from the laser diodes can be caught within the reflector in order to achieve absorption of this radiation by the active medium in a more efficient manner.

Moreover, the active medium has a cylindrical shape and the reflector is arranged concentrically around the active medium. This provides an absorption profile of the pumping radiation that is emitted from the laser diodes that is symmetrical with respect to the longitudinal axis of the active medium.

Furthermore, in order to solve the above problem, a method for pumping an active medium of a laser system with a plurality of laser diodes is provided, the method being characterized in that the active medium is pumped continuously during pumping periods of a predetermined duration, the pumping periods being provided periodically and being separated by non-pumping periods, wherein, during each pumping period, at least two laser pulses are emitted from the active medium, wherein each of the at least two laser pulses is caused by a corresponding Q-switch operation in the pumping period. Therefore, energy losses of a laser pulse being emitted from the active medium can be reduced and the amount of laser pulses being emitted within a specific time period can be increased while maintaining the thermal load of the laser system, in particular of the active medium at the same level.

This method can be further characterized in that each pumping period has a duration of more or less than 50 μs or 100 μs or 250 μs or 1 ms or 5 ms or 10 ms and/or each non-pumping period has a duration of more or less than 1 ms or 2 ms or 5 ms or 10 ms or 20 ms or 50 ms or 100 ms. Such longer pumping periods allow the active medium to transmit a plurality of laser pulses.

According to another embodiment, the method is characterized in that the duration of the non-pumping period is equal to the duration of the pumping period or the duration of the non-pumping period is not equal to the duration of the pumping period. Equal pumping periods and non-pumping periods can improve the output of the laser system with respect to a continuous emission of radiation. In contrast thereto, non-pumping periods being either longer or shorter than the pumping periods can, on the one side, lead to more laser pulses being emitted (if the non-pumping period is shorter than the pumping period) or, on the other side, to the active medium being protected from unintended damage due to thermal stress if the non-pumping period is longer than the pumping period.

According to a further embodiment, the power by which the active medium is pumped is at least 100 W, or at least 500 W, or at least more than 1000 W. Due to the non-pumping periods being provided after each pumping period, relatively high pumping power can be utilized in order to pump the active medium.

A laser system can be provided that comprises an active medium and a plurality of laser diodes, adapted to pump said active medium, characterized in that the laser system is suitable to operate according to one of the above method and wherein the laser system is a laser system according to one of the above laser systems. Such a system provides the advantages explained above.

The laser system for generating laser pulses according to the invention comprises a pumpable, solid state active medium, a plurality of pumping laser diodes for pumping the active medium, that are arranged in a cylinder mantle in parallel to a longitudinal axis of the active medium, and a resonator comprising first and second optical systems, wherein the first optical system is arranged on one side of the active medium and is adapted to reflect back radiation emitted from the active medium into the active medium, and the second optical system is arranged on an opposite side of the active medium and is adapted to reflect back radiation emitted from the active medium into the active medium, and is characterized in that a main plane of the first optical system extends perpendicular to the longitudinal axis of the active medium and is placed inside the active medium. This allows for effectively compensating the thermal lens of the active medium and therefore results in a more accurately modulated TEM₀₀ mode of the laser pulse.

In one embodiment, the main plane is placed in a distance of at least L/10, or at least L/5, or at least L/4, or at least L/3 of the side of the active medium at which the first optical system is arranged, or in the center of the active medium, wherein L is the extent of the active medium in the longitudinal direction. By appropriately adjusting the first optical system in order to place the main plane, the requirements regarding compensation of the thermal lens can be fulfilled.

Further, the first optical system may comprise a telescope and a planar mirror. This arrangement of the first optical system is comparably simple, and, therefore, less failure prone.

According to a further development of this embodiment, the telescope comprises a convex lens and concave lens, the convex lens being arranged closer to the active medium as the concave lens. Thus, radiation reflected back into the active medium is focused by the convex lens before entering the active medium, thus compensating the thermal lens of the active medium.

The laser system may be characterized in that the second optical system comprises a parabolic mirror, or a spherical mirror, arranged and adapted to reflect back radiation emitted from the active medium into the active medium. This mirror can be used to further focus the radiation emitted from the active medium into the active medium.

Further, the laser system may comprise a Nd:YLF crystal rod or a Nd:YAG rod as active medium. Nd:YLF crystals result in laser pulses having higher energy, although the pulse duration is longer, whereas ND:YAG crystals result in shorter pulses having less energy.

Still further, in one embodiment, the laser system is characterized in that the total output power of the laser diodes is between 5000 W and 6000 W, preferably between 5200 W to 5600 W, most preferred 5400 W. By choosing a corresponding total output power of the laser diodes, the resulting pulse power and the thermal stress applied to the active medium can be controlled.

Moreover, the laser system may be adapted to generate pulses having a duration between 15 ns and 30 ns, preferably between 20 ns and 25 ns, the laser pulses having an energy of 150 mJ.

Advantageously, the laser system comprises a variable Q-switch that is adapted to have an adjustable switch point, wherein the time between switch points, corresponding to successive laser pulses, can be varied. Thereby, the moment of the actual generation and transmission of the laser pulse can be adjusted, for example, depending on other conditions like actual temperature. This is especially advantageous when the laser pulse is to be applied on further objects in a time-dependent manner.

It might also be provided that the first optical system is adapted to reflect back radiation emitted by the active medium into the active medium such that a percentage of the surface of the active medium, onto which the reflected radiation falls, is illuminated by the reflected radiation, wherein the percentage is at least 95%, preferably at least 98%, most preferred more than 99%. Thereby, almost the complete active medium is illuminated by the reflected radiation leading to a higher number of photons being generated in the excited active medium by stimulated emission.

In one embodiment, the laser system is characterized in that the first optical system can be adjusted depending on the temperature of the active medium with respect to at least one optical property of the first optical system. Thereby, the optical characteristics of the first optical system can be adjusted to match, at different temperatures, the requirements for compensating the thermal lens of the active medium, which is temperature dependent.

A method for generating laser pulses is provided by using a laser system according to any of the preceding embodiments. By applying the laser system in a method for generating laser pulses, the above-described advantages can be used in generating TEM₀₀ modes.

In one embodiment, the method is characterized in that the time between switch points, corresponding to successive laser pulses, of the Q-switch is varied. By varying the time between the switch points, the actual emission of a laser pulse can be adjusted and, therefore, the laser pulses can be generated and applied to, for example, other objects at well-defined times, which may not be periodically but rather irregular.

Further, the duration of pumping phases during which the active medium may be pumped is adjusted in accordance with a pulse generation frequency. Thereby, the pumping periods are adapted in accordance with the pulse generation frequency in order to generate a high energy density within the active medium, before generating the laser pulse.

In one advantageous modification, the method is characterized in that at least one property of the first optical system is adjusted depending on the temperature of the active medium, wherein the location of the main plane of the first optical system within the active medium or the refractive power or the magnification of the first optical system is changed. Thus, the arrangement of the main plane of the first optical system can be shifted or the refractive power or the magnification can be adapted in order to maintain compensation of the thermal lens effect of the active medium even when the temperature within the active medium changes.

### BRIEF DESCRIPTION OF THE DRAWINGS

FIG. 1: Schematic depiction of a laser system according to one embodiment of the description

FIG. 2a-2c: Schematic depiction of the emission profile of a laser diode according to one embodiment

FIG. 3: Schematic depiction of an arrangement of multiple blocks of laser diodes according to one embodiment of the invention.

FIG. 4: Schematic depiction of the reflector according to one embodiment of the invention

FIG. 5: Schematic depiction of the reflector according to one embodiment of the invention

FIG. 6: Schematic depiction of the graphs showing different pumping procedures

FIG. 7: Schematic depiction of the cooling device according to one embodiment of the invention

FIG. 8: Schematic depiction of the case according to one embodiment of the invention

FIG. 9: A schematic depiction of a laser system according to one embodiment of the invention

FIG. 10: A more detailed depiction of a laser system according to one embodiment of the invention

FIG. 11a-11c: Modification of the position of the main plane according to one embodiment of the invention

FIG. 12: Schematic depiction of a pumping and Q-switching procedure according to one embodiment of the invention.

### DETAILED DESCRIPTION

1) Arrangement of Laser Diode

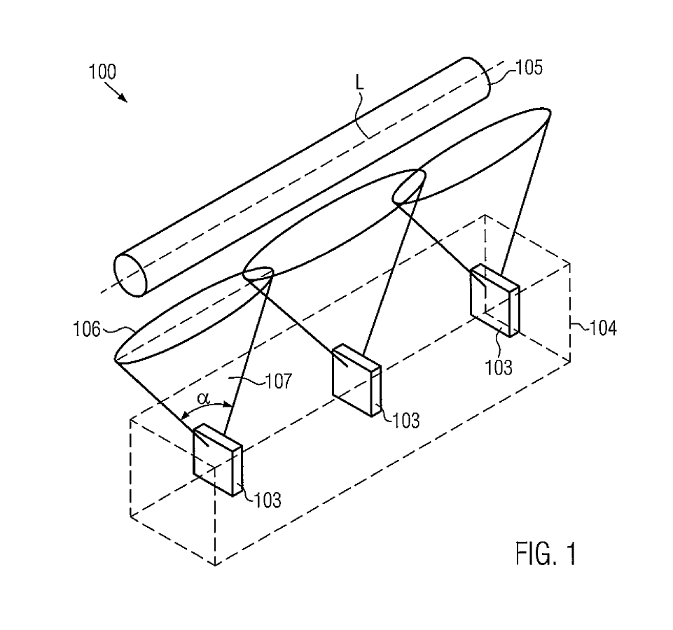

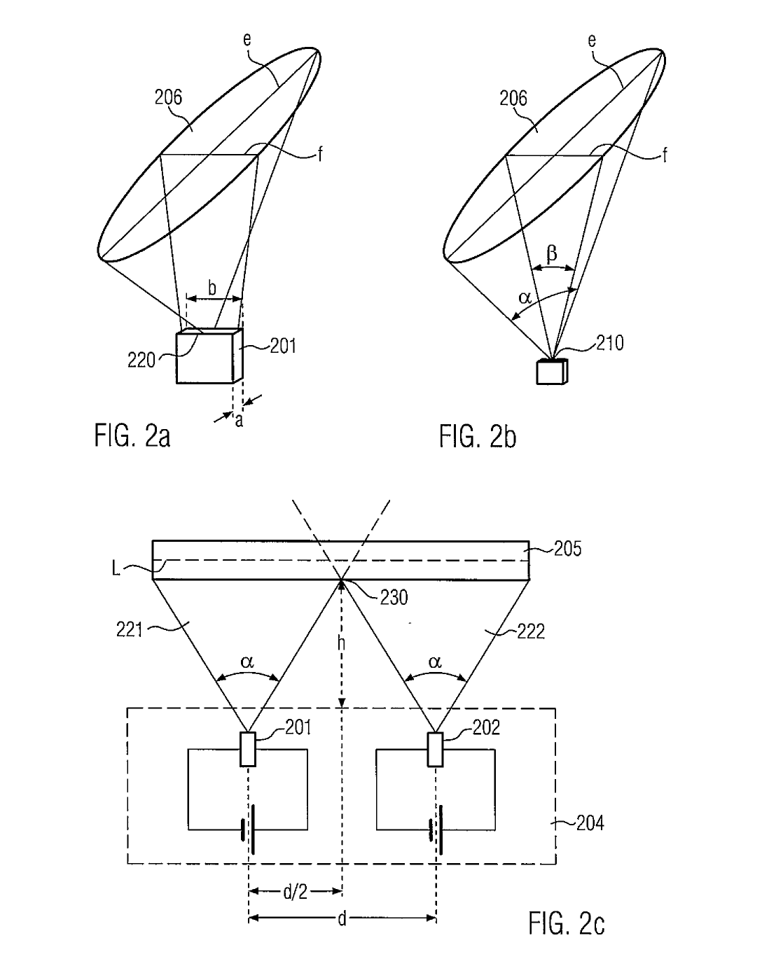

FIG. 1 shows a schematic depiction of a laser system 100 according to one embodiment of the invention. This laser system comprises one active medium 105 that might be a Nd:YAG or other solid state crystal that is capable of emitting laser radiation. According to the invention, this active medium is pumped with at least one, and preferably a plurality of, laser diodes 101-103. These diodes might advantageously be arranged within a block 104. Preferably, the arrangement of the laser diodes is such that they are all arranged on a line that is parallel to the longitudinal axis of the preferably cylindrical active medium 105. Thereby, a homogeneous pumping profile with respect to the radiation inciting on the active medium can be achieved. In block 104, the laser diodes 101-103 are arranged and further devices, such as cooling devices and power supply units for the laser diodes can be provided. In view of FIG. 1, the arrangement of the laser diodes 101-103 is such that their elliptical emission profile 106 incites on the active medium 105 such that the plane 107 that corresponds to the greatest emission angle α is in parallel to the longitudinal axis of the active medium 105. This will be further explained with reference to FIG. 2.

The end surfaces of the active medium 105 can be cut at an angle different from 90° with respect to the longitudinal axis of the (cylindrical) active medium 105.

In FIG. 2a, an enlarged and schematic depiction of one of the laser emitting diodes 201, that are arranged in block 104 in FIG. 1, is shown. This laser diode has, for example, a cuboid shape. Laser radiation is emitted from the laser diode 201 from the surface 220. As the shape of this surface is rectangular as well, the corresponding emission profile is an ellipse that is defined by half axes e and f. Depending on the relation of the length a to the length b, one of the half axes can be much longer that the other.

FIG. 2b shows a more detailed image of the emission profile. It is noted that, when it is referred to the emission profile in this application, this profile is defined by the amount of radiation having an intensity that is equal to

$$\frac{1}{e}$$

or more of the maximum intensity in a section perpendicular to the optical axis of the laser diode (typically in the centre of such a section). The intensity of

$$\frac{1}{e}$$

the maximum intensity in the section in which the axes e and f are given define the length of the axes e and f. It is therefore assumed that the emission of radiation from the laser diode is limited to this region, which is defined by a cone having a ground surface of elliptical shape with half axes e and f and a peak point on the surface of the laser diode 210. Therefore, this profile is defined by the half axes e and f and the angle α and β that correspond to cross sections of the cone that are defined by the peak point and the half axes e and f respectively. Although outside the cone radiation is emitted from the laser diode, the intensity of this radiation is much smaller that the intensity of the radiation emitted within the cone. Therefore, in order to provide reasonable dimensions for the size of specific components, reference is made to the emission profile being only defined by radiation being emitted within the cone, being defined by peak point 210 on the laser diode shown in FIG. 2b and the angles α and β and the half axes e and f respectively.

Taking this into account, it is the finding of the present invention that, as shown in FIG. 2c, the laser emitting diodes are arranged such that radiation being emitted under the angle α, i.e. corresponding to radiation being emitted in the cross-section of the cone defined by the emission point 210 and the greater half axis e travels in parallel to the longitudinal axis L of the active medium 205. It can be advantageous to allow the radiation, being emitted by two adjacent laser diodes, to overlap before on the boundary surface of the active medium 205, thereby ensuring that the complete active medium 205 receives energy from the laser diodes and can, therefore, be pumped (homogeneously). In order to achieve this, the distance of the laser emitting diodes with respect to the boundary surface of the active medium 205, and the distance between two adjacent laser diodes 201 and 202, has to fulfill a specific relationship that depends on the angle α of the radiation emission profile 221 of the first laser diode 201 and the emission profile 222 of the second laser diode 202. It is assumed that the emission profile of both laser diodes is the same. If laser diodes 201 and 202 are placed at a distance d from each other, they have to be positioned at a distance h from the boundary surface of the active medium 205, such that the distance h is given by

$$h \geq tan ( \frac{π}{2} - \frac{α}{2} ) \cdot \frac{d}{2} .$$

Thereby, the emission profiles of the first laser diode 201 and the second laser diode 202 overlap at point 230. If the laser diodes 201 and 202 are arranged at a distance h, fulfilling the equal relation of the equation above, the emission profile will overlap right on the boundary surface of the active medium 205. In case the distance h is longer, emission profiles 221 and 222 of the laser diodes 201 and 202, respectively, overlap before reaching the active medium 205. It can be advantageous to arrange the laser diodes 201 and 202 at a distance h being slightly greater than the distance h that would fulfill the equal relation in the above equation, in order to take into account deviations due to thermal stress to the laser diodes 201 and 202 while pumping, or to compensate thermal expansion of the active medium 205 in a radial direction.

In the prior art, laser diodes have typically been arranged with the short axis f being parallel to the longitudinal axis since, thereby, the laser diodes could be provided in the form of laser bars, wherein neighboring laser diodes are conveniently placed on a common heat sink. The present disclosure deviates from this concept. It is not strictly necessary that the long axis e be perfectly parallel to the longitudinal axis of the active medium 205 since the advantage of the present disclosure can also be achieved if the longitudinal axis has an angle of less than 45°, or less than 30°, 20°, or 10° with respect to the longitudinal axis of the active medium. Hence, the effect of the invention can also be achieved if the radiation plane of laser radiation emitted from the laser diode(s) and corresponding to the greatest emission angle α is oblique (i.e. not perpendicular) to the longitudinal axis of the active medium, optionally at an angle of less than 45°, or less than 30°, or less than 20°, or less than 10°.

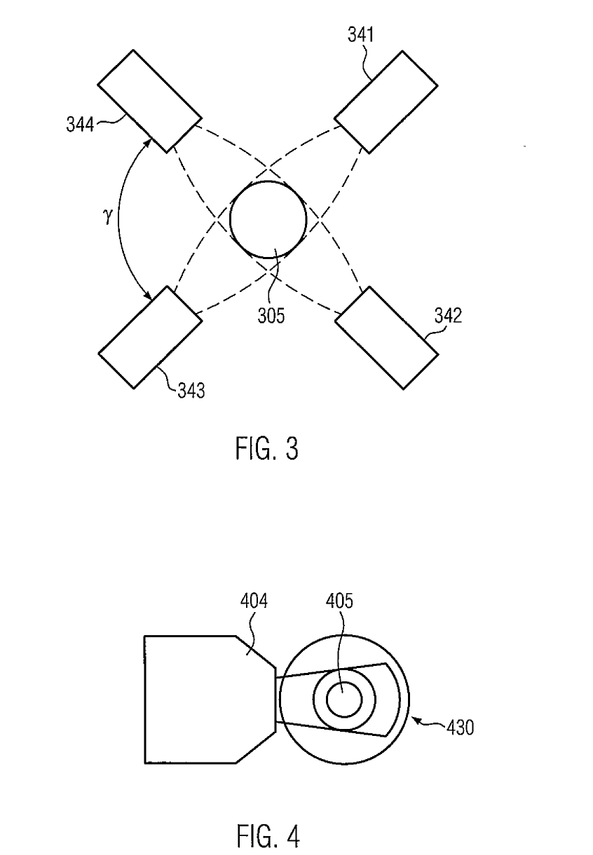

In order to provide an even more homogeneous emission profile that leads to pumping of the active medium, FIG. 3 shows an arrangement wherein multiple blocks 341-344 are arranged at a distance (for example the distance h described before) from an active medium 305. In order to provide for a preferably homogeneous pumping profile (i.e. the radiation that incides at a given point of the active medium 305 when taking into account radiation that incides on this point from any of the blocks 341-344 and the laser diodes included there), it can be advantageous to arrange the blocks 341-344 with an angular distance to each other, wherein the angular distance of two adjacent blocks, 343 and 344 for example, is the same for each pair of adjacent blocks 341-344 and is given by γ, wherein γ is defined by

$$\frac{2 π}{n} ,$$

where n is the total number of blocks. Thereby, the blocks 341-344 form an equilateral n-gon. Thereby, rotational symmetry of the pumping profile can be (nearly) achieved. In view of this, it is even more advantageous if the number n of blocks 341-344 is even.

In order to enhance the pumping process even further, it can be advantageous to provide a reflector that surrounds the active medium 405, wherein this reflector comprises portions as shown in FIG. 4, through which the radiation that is emitted from the laser diodes in the block 401 can be transmitted. When this radiation incides on the opposing inner surface of the reflector 430, this radiation is reflected. Preferably, the complete inciding emission is reflected from the inner surface of the reflector, such that it incides on active medium 405. Thereby, the pumping radiation being emitted from the laser diodes can be absorbed to a high degree from the active medium. Preferably, the degree of absorption is at least 90%, or even more.

2) Reflector

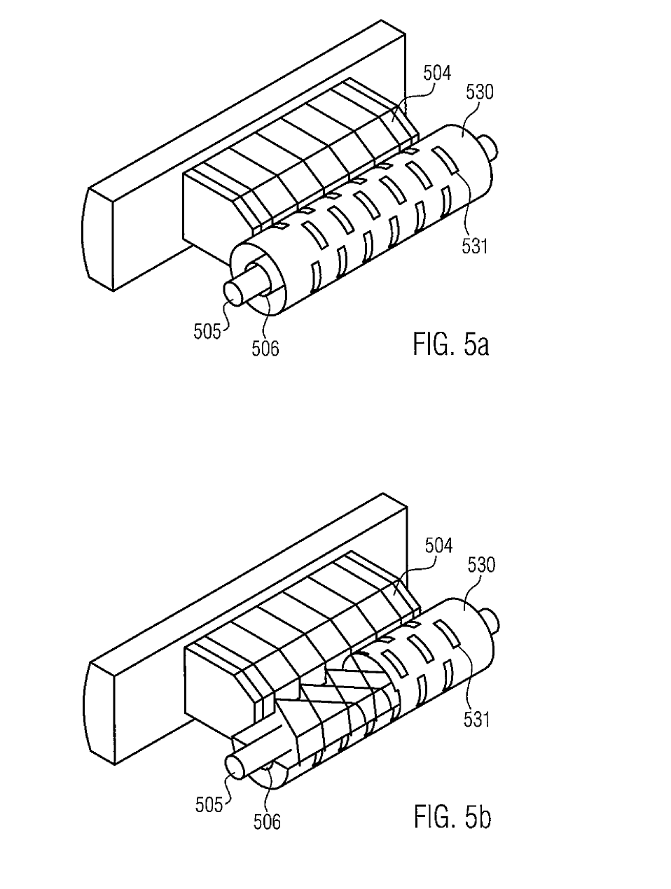

Typically, a quartz cylinder, being coated with for example a gold coating, is used for the reflector. Such coatings tend to detach from the quartz cylinder in particular under heavy thermal load. The coating is mechanically too weak to be self supporting and is supported by the quartz cylinder. In order to enhance manufacturing processes and reliability, a self-supported cylinder of a radiation reflecting metal, such as copper, can be used. FIG. 5a shows a corresponding arrangement of the reflector 530 being arranged around the active medium 505. This reflector can be arranged such that the advantageous effects of a correspondingly arranged system of laser diodes as described above can be provided, although using a corresponding reflector being made of a self-supported metal cylinder, can be advantageous in any way. In view of FIG. 5a, the reflector has a cylindrical shape, as has the active medium 505. Further, the reflector 530 is placed at a distance from the active medium 505. In the space between the active medium 505 and the reflector 530, a cooling agent such as water can be inserted and/or circulated. However, as the self-supported reflector 530 is made of metal, which preferably is a very good heat conductor (like iron, copper, gold, or silver), a cooling agent being inserted in the space 506 between the reflector 530 and the active medium can be omitted in case the heat which is transferred from the active medium 505 to the reflector 530 is transported out of the system by efficiently cooling the reflector 530. This yields a further miniaturization of a corresponding laser system and provides an additional advantage in view of reflecting the laser radiation being emitted from laser diodes in order to pump the active medium, since this radiation will no longer have to pass through the cooling agent which would lead to an amount of energy being absorbed in the cooling agent.

As can be seen in FIG. 5b, the reflector 530 comprises gap portions 531. These gap portions 531 are arranged such that radiation being emitted from laser diodes that are arranged in block 504 can be transmitted through the reflector onto the active medium 505 in order to pump said active medium. As the reflector 530 can be manufactured for example with the help of milling and/or cutting and/or drilling processes, these portions 531 can be placed very precisely in order to allow a maximum amount of radiation to be transmitted through the portions 531 from the laser diodes in block 504. In order to further stabilize the active medium 505 and the reflector 530, it can be advantageous to provide a quartz cylinder that is placed between the active medium 505 and the reflector 530 and is joined to the reflector 530. Further, it can be advantageous to join the quartz cylinder to the active medium. In view of this, and in case the active medium has a cylindrical shape, it is preferred that the reflector 530 is arranged concentrically around the active medium with respect to the longitudinal axis of the active medium. In case a quartz cylinder is used, the same holds for this quartz cylinder.

The reflector may be made of copper, which has good heat conductivity and good reflectivity in the infrared radiation region and has good manufacturability. The thickness of the wall of the reflector may be in the range of 0.5 mm to 2 mm, such as between 0.75 mm and 1.25 mm.

3) Improved Pump Procedure

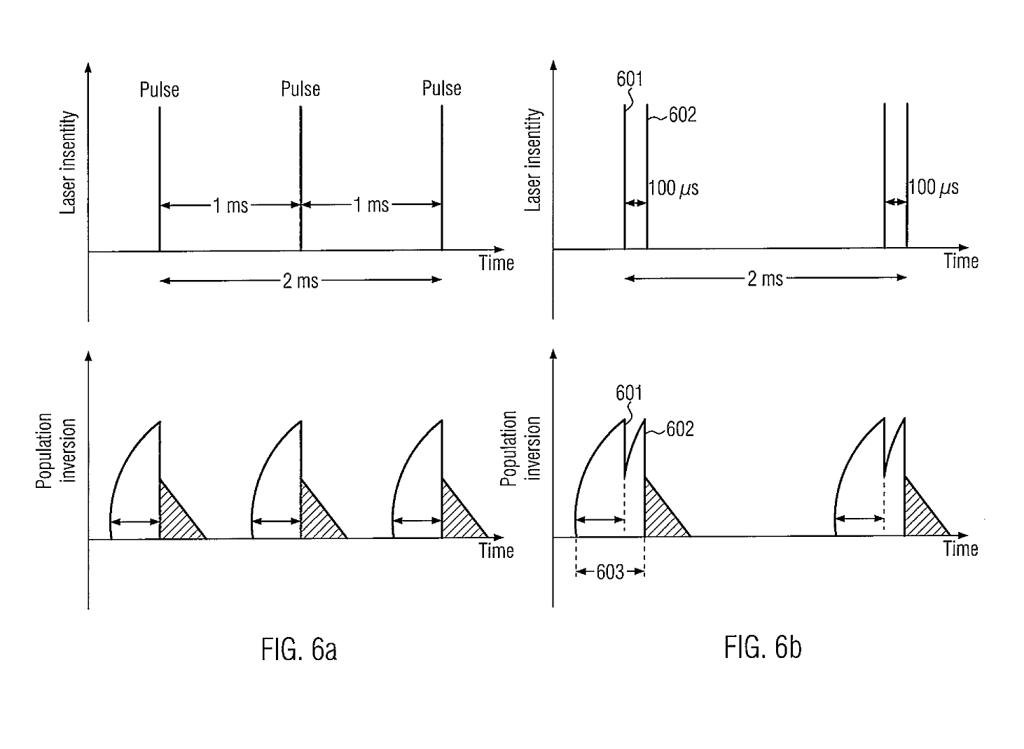

In a further aspect of the present invention, a method for pumping an active medium of a laser system is provided that provides advantages with respect to the efficiency of the pumping process. In order to illustrate this advantage and how this method works, FIGS. 6a and 6b show a comparison between laser systems according to the prior art (FIG. 6a) and a laser system that is pumped according to the inventive method provided here.

The laser system as shown in FIGS. 1 to 5, or any other laser system, is provided in a cavity which comprises a Q-switch element, such as a Pockels cell. Thereby, the emission of pulses from the active medium can be controlled. It is sufficient to have an active laser medium and the Q-switch element within the laser cavity. One of the cavity mirrors may have a higher reflectivity than the other one.

According to FIG. 6a, within a time span of approximately 2 ms, three pulses are generated, each being separated from the other by 1 ms. It is noted that FIGS. 6a and 6b do only show a schematic depiction and, therefore, it is assumed that the pulses have an infinitely (i.e. relatively) short duration. In order to make the corresponding active medium emit laser energy with the shown laser intensity, a population inversion has to be generated in the active medium by pumping said active medium. This is shown in the second graph of FIG. 6a. Therefore, the active medium is pumped before the laser pulse is emitted, for example by a corresponding Q-switch operation. In case the necessary population inversion is reached, the Q-switch is operated and the first laser pulse is emitted. After that, the system returns to its ground state, thereby transmitting undirected and incoherent radiation which, for example, results in the heating of the active medium. It is to be noted that, in the prior art, the active medium is only pumped until the desired population inversion is reached. For each pulse, i.e. the first, second and third, shown in the first graph of FIG. 6a, a corresponding pumping process has to be carried out and, as shown in the gray area of the second graph of FIG. 6a, energy is lost after the Q-switch operation has ended and the emission of laser energy from the active medium is stopped.

In order to prevent this, the invention suggests a different approach. According to FIG. 6b, laser pulses are generated as couples or packets of pulses that are emitted within a short time of each other. After these two pulses have been emitted there is a break until the next pulses are emitted. This break is referred to herein as the non-pumping period. According to the invention, the two laser pulses 601 and 602 are emitted within one pumping period. As can be seen in the second graph of FIG. 6b, first, like in the prior art, in order to produce the population inversion for the first laser pulse 601, a population inversion is generated from the ground state of the system (i.e. the active medium). When the population inversion required for (high power) lasering is achieved, a Q-switch operation is carried out and the first laser pulse 601 is emitted. However, in contrast to the prior art lasers, the pumping period does not end with the emission of the first pulse but is continued. Therefore, a second laser pulse 602 can be generated by operating a Q-switch operation without the disadvantage of losing energy as in the prior art after creation of the first laser pulse due to the stop of the pumping process. When the second laser pulse 602 is transmitted, and the Q-switch operation has ended, the pumping may end as well. Therefore, the system then returns to the ground state. Therefore, some energy is lost as it is translated into incoherent radiation and heating of, for example, the active medium. However, compared to the prior art laser system, this loss of energy does not occur after each laser pulse but only after each pumping period, during which a plurality of laser pulses can be generated.

It is to be noted that a plurality of laser pulses can be generated depending on the duration of the pumping period and the pumping power. As an example, it might be intended to produce less than 2, 5, 10, or even 100 laser pulses within one pumping period. As this leads to stress and heating of the active medium and the corresponding laser diodes that pump the active medium, the non-pumping period may be very long in order to ensure that the components are not damaged. As an example, the pumping periods can have durations less than 200 μs, 500 μs, 1 ms, 2 ms, 5 ms, 10 ms, 20 ms, 50 ms, or even more milliseconds. Depending on the input power that is used by the laser diodes in order to pump the active medium, the non-pumping periods may be equally as long as the pumping periods, or maybe shorter, or maybe even longer. For example, depending on the input power, a pumping period that is 250 μs long may be followed by a non-pumping period that has a duration of 1750 μs, in case the input power is very high and yields a significant amount of stress to the above mentioned components. In case the input power is only moderate or low, the non-pumping period may have a duration of 1 ms, as has the pumping period, or even less, for example 50 μs. It is preferred that the pumping periods always have the same duration and, further, the non-pumping periods may also have the same, but perhaps different, duration. Therefore, the pumping periods are repeated periodically.

However, depending on the implementation within a laser system, it might also be advantageous to vary the duration of the non-pumping periods and/or the pumping periods in order to provide a more flexible laser system. For example, if a first plurality of 10 laser pulses is necessary, and in a following step, another plurality of 50 laser pulses is necessary, the first pumping period may have a duration of 100 ms and the second pumping period may have a duration of 500 ms. As the stress caused to the components in the first pumping period is comparably low, compared to the second pumping period, the non-pumping period may be short, for example 0.5 or 1 ms as well. As the stress to the components (active medium and laser diodes) is significantly higher in the second pumping period, the non-pumping period following this second pumping period may be much longer, for example 5 or 10 ms or even 200 ms.

As the above described method is very flexible, a variety of input powers can be used. For example, the input power for pumping the active medium can be more than 100 W or more than 500 W, or even more than 1000 W. Depending on the non-pumping period, each of the laser diodes may provide a corresponding amount of input power with which the active medium is pumped.

4) Improved Cooling Device

According to this embodiment, a cooling device is provided for a laser system like those mentioned above, wherein this cooling device comprises at least one sensor for measuring the flow of the cooling agent and/or the temperature of the cooling agent, wherein this sensor is adapted to transmit, to a control unit, a signal being indicative of the flow of the cooling agent and/or the temperature of the cooling agent, and the control unit being adapted to control a cooling agent supply, based on the received signal.

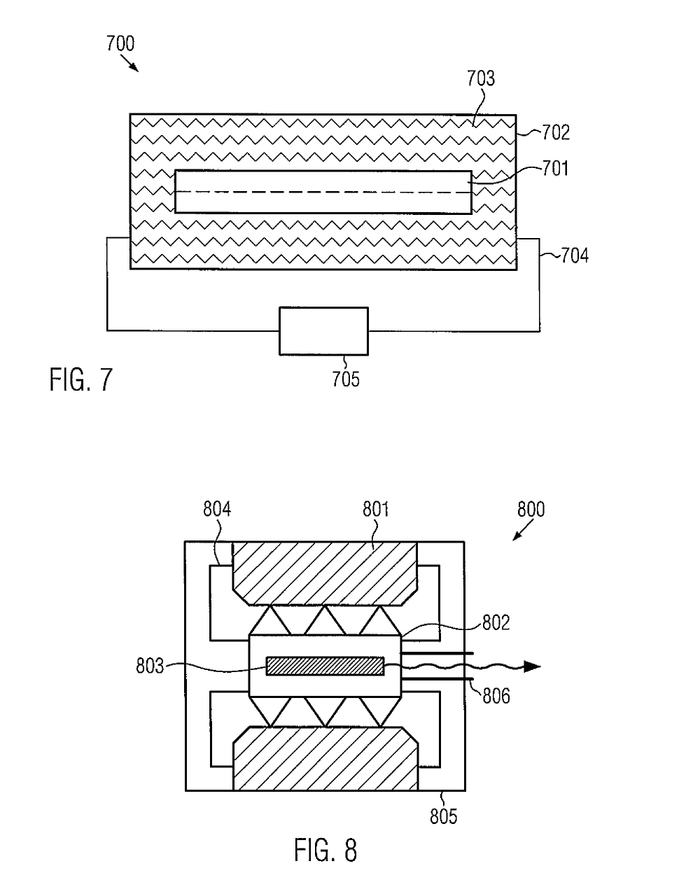

As an example, FIG. 7 shows a corresponding laser system with the cooling system according to the invention. The laser system according to the invention comprises an active medium 701, a case 702, that at least partially, or only partially, surrounds the active medium 701, a cooling agent supply 705, and supply line 704 that is adapted to provide the cooling agent to the inside of the case and to transmit used cooling agent from the case 702 to the cooling agent supply 705. The cooling agent supply may cool down used cooling agent before again providing it to the supply line 704. The cooling agent can be, for example, water, or any other suitable fluid. A fluid may be used whose thermal expansion coefficient is small.

According to one embodiment, a plurality of sensors is provided in the case 702, preferably on the inner surface of the case 702. In view of this, it can be advantageous to provide the plurality of sensors such that adjacent sensors with respect to the longitudinal axis L of the active medium 701 are arranged at equidistant distances. The data obtained from the sensor can also be used to calculate a temperature gradient and providing a corresponding signal to the cooling agent supply 705. Depending on the temperature gradient of the cooling agent, the flow of the cooling agent, and the pressure with which the cooling agent is pumped into the case 702, can be increased or decreased. As an example, in case the temperature gradient shows that the cooling agent is heated by the active medium 701 to a critical temperature before passing at least three quarters of the length of the case 702, the cooling agent supply 705 can control the flow of the cooling agent such that more cooling agent is pumped inside the case 702 and is conducted away from the case 702. Preferably, the inlet and the outlet of the supply line 704 are, as shown in FIG. 7, on opposing sides of the case 702. It can also be advantageous to provide more than one supply line, not only to ensure cooling even if one of the supply lines fails, but also to increase the flow rate of the cooling agent.

The sensors, or only one sensor, may also be provided in the supply line 704, in particular in the portion leading cooling agent from the case 702 to the cooling agent supply 705.

5) Miniaturized Laser System

In order to increase the efficiency of prior art laser systems and laser systems in accordance with the above-explained embodiments, a miniaturized laser system is provided. According to this embodiment of the invention, a complete laser system 800 is provided within an electromagnetically almost completely sealed box 805, wherein the laser system comprises an active medium 803, a case 802 that surrounds the active medium 803, and may be provided with a laterally surrounding reflector, and further laser diodes being arranged in blocks 801 for pumping the active medium 803. Preferably, the box 805 only comprises one opening 806 through which the radiation emitted from the active medium can be emitted. Such enclosure of components of the laser system prevents unintended emission of electromagnetic radiation. Further, according to one embodiment, the length of current carrying conduits, like cables, is reduced to the minimum length wherein, preferably, the whole conduit is placed within the box 805. Preferably, only one conduit connection is provided that connects the laser system 800 with an energy supply. Such a casing of a laser system renders the laser system suitable for application, at for example a hospital, as potentially dangerous radiation is no longer emitted from the device 800.

In order to further reduce the amount of electromagnetic radiation that is emitted, there can be provided a channel, from the opening 806, to the active medium 803 that is on a boundary surface sealed against transmission of electromagnetic radiation other than that emitted from the active medium.

A supply of cooling agent may be provided outside of the laser system 800.

Optionally, all electronics that operate in a pulsed mode for driving the laser diodes are contained within the box 805. A power supply to the box 805 may be a DC or an AC power supply (at e.g. 50 or 60 Hz), which, lower, does not provide a pulsed mode for driving the laser diodes.

6) Laser System for Generating Laser Pulses

This part of the invention relates to a laser system for generating laser pulses, especially laser pulses having a short duration and high energy.

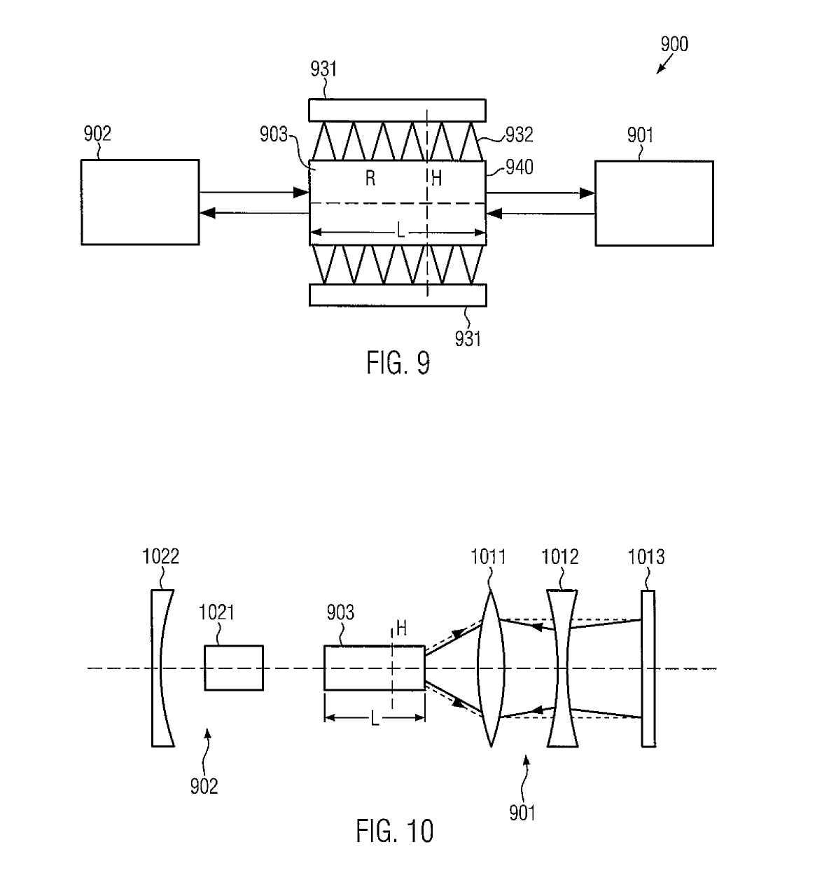

FIG. 9 shows an exemplary schematic depiction of a laser system 900 according to one embodiment of the invention. The laser system 900 comprises an active medium 903 that is placed between a resonator comprising two optical systems, a first optical system 901 and a second optical system 902. As commonly known in the art, at least one of the optical systems will be adapted to transmit a generated laser beam out of the system. This can be achieved by for example Q-switching a Pockels cell in one of the optical systems. Utilizing Pockels cells and Q-switches is well known in the art and will not be explained in further detail here. It is preferred that the active medium is adapted to emit laser pulses (TEM₀₀-modes) at energies around 150 mJ, preferably between 130 mJ-200 mJ. The pulse duration should be between 15-30 ns, preferably 20-25 ns.

Further, the laser system 900 may comprise one or more laser diodes or laser diode arrays 931 for pumping 932 the active medium. These laser diodes may be arranged in a cylinder mantel surrounding the active medium 903 and being in parallel to a longitudinal axis R of the active medium, as explained above, and have a total pumping power of 5000 W-6000 W, preferably 5200 W-5600 W, most preferred 5400 W. The optical systems 901 and 902 of the resonator are placed at both sides of the active medium 903 in extension of the longitudinal axis R. The optical properties of the first optical system 901 are such that the main plane H of the optical system 901 extends perpendicular to the longitudinal axis of the active medium and is placed inside the active medium. The position of the main plane H with respect to an optical system that comprises two lenses having focal lengths f₁ and f₂ is given by

$$\overline{{HH}_{1}} = \frac{{f}_{1} d}{d - {f}_{1} - {f}_{2}} ,$$

wherein d is the distance between the lenses and H₁ being the main plane of the lens being arranged closer to the active medium. By placing the main plane H like this within the active medium, influence of the thermal lens of the active medium 903, which is an inevitable effect due to heating of the active medium 903 through pumping, can be efficiently compensated for. In order to achieve this, the main plane H may be placed within the active medium, having the length L, for example at a distance of LI/10 or L/5, or L/4, or L/3, from the side of the active medium which is closer to the first optical system. In the exemplary embodiment shown in FIG. 9, for example, the main plane H is placed at a distance of approximately L/3 from the side 940, at which the optical system is arranged. In a preferred embodiment, the main plane is arranged in the center of the active medium.

FIG. 10 shows a more detailed view of the optical systems and the active medium 903. For simplicity's sake only, the laser diodes shown in FIG. 9 are omitted here. As can be seen in FIG. 10, the first optical system 901 comprises a convex lens, a concave lens, and a planar mirror. The convex lens 1011 is placed closer to the active medium 903 than the concave lens 1012. Likewise, the concave lens 1012 is placed closer to the active medium 903 than the planar mirror 1013. Thereby, radiation being emitted from the active medium 903 while being pumped travels through the convex lens 1011 where it is focused. It then travels through the concave lens 1012 where it is defocused and, finally, reaches the mirror 1013, where it is reflected back into the concave lens 1012 and the convex lens 1011 which focuses the radiation back into the active medium 903. Due to the main plane H lying within the active medium 903, the thermal lens caused by thermal stress of the active medium 903 while being pumped is sufficiently compensated for, which results in an almost perfectly modulated TEM₀₀ mode, when Q-switching the system in order to generate the laser pulse, since deviations from the TEM₀₀ are caused to a high extent by the influence of the thermal lens of the active medium, which is difficult to control.

The second optical system 902 in this embodiment comprises a spherical or parabolic mirror 1022 placed at a distance from the other side of the active medium 903 and means 1021 for switching the resonator. Means 1021 may comprise a Pockels cell as well as λ/4 plate. The mirror 1022 may also be replaced by another optical system comprising a concave lens, being arranged closer to the active medium than a further convex lens and the parabolic mirror.

The active medium 903 may comprise or may consist of an Nd:YAG crystal rod or, preferably, an Nd:YLF crystal rod. The advantage of Nd:YLF crystal rods as an active medium is its long fluorescence lifetime compared to Nd:YAG lasers. Although this results in an even higher energy density within the active medium 903, the thermal lens caused by the accordingly high thermal stress in the active medium is sufficiently compensated for by the optical system 901, thereby resulting in TEM₀₀ laser pulse modes of the Nd:YLF crystal rod having a higher beam quality. Likewise, compared to Nd:YAG crystals, Nd:YLF crystals provide higher pulse energies. Thus, the laser system provided here can be used, for example, to imprint special marks or even dots onto a given surface.

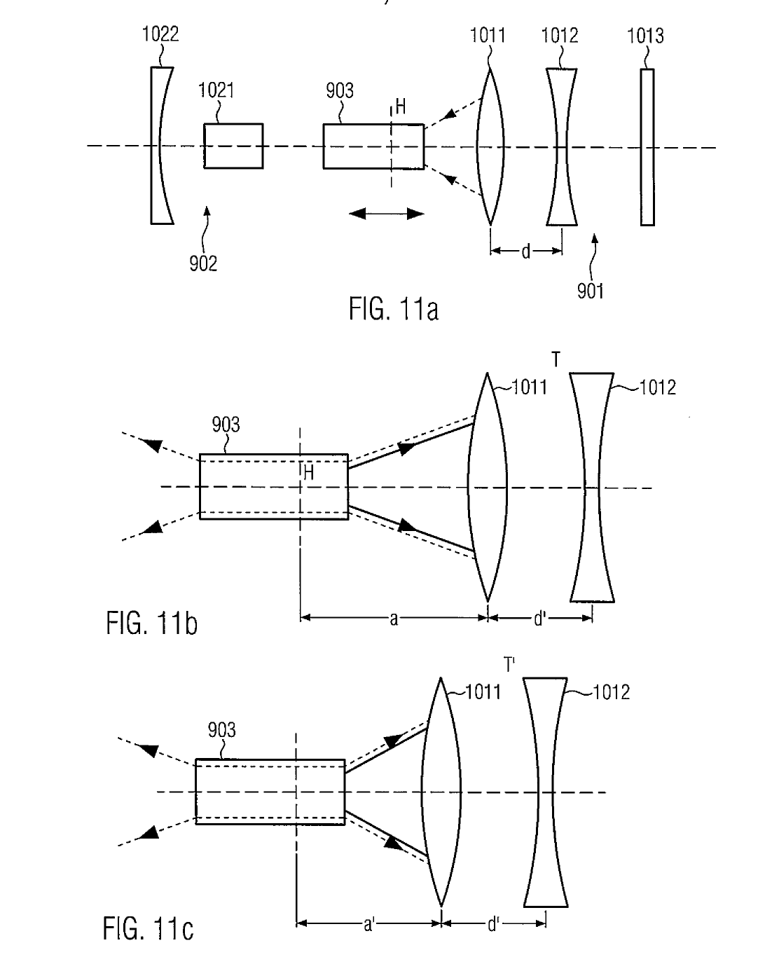

The effect of the thermal lens is strongly temperature dependent. In order to compensate for this, the embodiment shown in FIGS. 11a-11c allows for modifying the optical characteristics of the first optical system 901 in accordance with a rise or fall in temperature of the active medium 903.

FIG. 3a shows the principle arrangement in which the position of the main plane H can be changed within the active medium by, for example, changing the distance d between the convex lens 1011 and the concave lens 1012. Since by changing the distance of the convex lens and concave lens, the actual focal length of the optical system is changed, the degree of focusing or defocusing of radiation emitted from the active medium 903 and traveling through the first optical system 901 can be influenced. In fact, the distance between the main plane H and the main plane H₁ of the convex lens is given by

$$\overline{{HH}_{1}} = \frac{{f}_{1} d}{d - {f}_{1} - {f}_{2}} ,$$

wherein f₁ is the front vertex focal length of the concave lens and f₂ is the front vertex focal length of the convex lens and d is the distance between the convex and the concave lens.

By manipulating the distance between the lenses, for example by moving the concave or the convex lens or both, the position of the main plane H can be altered and the resulting focal length of the optical system can be manipulated. Thus, as shown in FIGS. 11b and 11c, it is possible to achieve refocusing of radiation, emitted by the active medium, back into the active medium after it passed through the first optical system, such that preferably the whole active medium is illuminated by the reflected radiation. This yields more stimulated relaxation of the electrons and therefore will increase the number of photons generated in the active medium, irrespective of a rise in temperature. Since, when temperature rises within the active medium 903, the defocusing effect of the thermal lens of the active medium 903 increases as well, it is preferred that with rising temperature the focal length of the first optical system is reduced. This will result in the first optical system focusing the radiation back into the active medium much stronger and, thereby, the increasing effect of the thermal lens at rising temperature is compensated for. Still further, providing the optical system in an embodiment such that the optical characteristics with respect to the position of the main plane and the focal length of the system can be manipulated, it is also possible to influence the percentage of the surface of the active medium onto which the reflective radiation falls. For example, with such an arrangement it is possible to illuminate 95 or even more, for example 98 or even 99% or more of the surface of the active medium 903, thereby ensuring that, while the radiation travels through the active medium, stimulated emission is achieved through preferably the complete extension of the active medium perpendicular to its longitudinal axis.

Thus, it is not only possible to ensure compensation of the thermal lens effect of a heated active medium, but also to adjust the percentage of the surface of the active medium that is illuminated with the radiation reflected back into the active medium, thereby influencing the degree of stimulated emission of further photons during the pumping procedure.

It is further noted that manipulating the distance between the lenses of the first optical system is not the only opportunity to change the position of the main plane and the focal length of the first optical system. Indeed, by changing the focal lengths of the lenses or by changing the refractive power of the first optical system or its magnification, the position of the main plan and/or the focal length or the refractive power can respectively be changed in order to compensate for the thermal lens effect of the active medium.

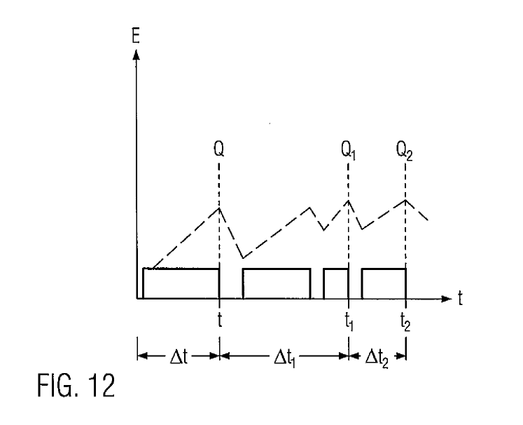

FIG. 12 shows a further embodiment that is correlated with the actual generation of the laser pulse. In FIG. 12, the pumping periods are shown with respect to the time. The pumping diodes are provided to pump the system within repeated pumping periods. Thereby, the amount of energy due to excitation of electrons within the active medium grows. Once the pumping ends, the excited electrons relax into the ground state, depending on the lifetime of the excited state The Q-switch is provided in order to make the laser system emit a laser pulse which is indicated in FIG. 12 by points Q, Q1, and Q2, and the corresponding times t, t₁, and t₂. Since it is preferred that the energy density (i.e. number of photons) in the active medium is as high as possible before generating the laser pulse (i.e. Q-switching the system), the pumping periods may be altered depending on the times at which the Q-switch is to be switched. Further, the times t, t1, and t2 may be variable such that, in one exemplary case, the time between a first Q-switching and a second Q-switching, for example Q and Q1, takes place within the time interval Δt₁ equaling for example 300 ms. On the other hand, a further Q-switching Q2 may take place after a time Δt₂ after the Q-switching Q1. In case Δt₁ and Δt₂ are not equal, the time that is available for pumping the active medium for the Q-switching Q2 is shorter than that for Q1. In order to nevertheless achieve energy density within the active medium before Q-switching at time t₂ that is almost equal to the energy density at t₁, the time interval for each pumping period may be altered and, likewise, the time between two adjacent pumping periods may be shorter in order to reduce energy loss within the active medium through relaxation of electrons into the ground state. Thereby, it can be ensured that each of the generated laser pulses have an energy of at least 150 mJ.

This is advantageous for example in applications of the laser system when printing or marking objects that are conveyed to the laser system. For example, one might consider metal containers like cans or tins that are to be marked with a symbol or a simple dot by the laser system. Although these cans may be transported at high accuracy having a distance of for example 5 cm from each other, even slight deviations from these distances will result in a different time at which the corresponding container is in front of the laser system to be marked. In order to ensure marking of the container at the correct position, the Q-switching of the laser system may be performed depending on a specific timing signal which indicates that the container is in the correct position for marking. Thus, the times between two laser pulses emitted by the laser system may vary within a time span. By providing the laser system with a variable Q-switch and correspondingly varied pumping periods, correct marking of each and every container can be ensured.

It is noted that, in order to achieve a corresponding marking of containers, pumping energies of about 5400 W are required. Nevertheless, in order to generate laser pulses having high energy, it is, in any case, preferred that the total of the power of the laser diodes is between 5000 and 6000 W. When it comes to marking of containers, the total output power of the laser diodes may be preferably between 5200 and 5600 W and may preferably be 5400 W. Thus, by using an Nd:YLF crystal rod as active medium, laser pulses having a duration of 20-25 ns at 1.053 μm or 1.047 μm can be generated having an energy of about 150 mJ. Due to the above-described arrangement of the laser system, the generated TEM₀₀ mode of the laser pulse has a high beam quality and can, therefore, be efficiently used to locally transform matter by laser induced chemical or physical reactions.

1. A laser system for generating laser pulses, the system comprising a pumpable, solid state active medium, a plurality of pumping laser diodes for pumping the active medium, that are arranged in a cylinder mantle in parallel to a longitudinal axis of the active medium, and a resonator comprising first and second optical systems, wherein the first optical system is arranged on one side of the active medium and is adapted to reflect back radiation emitted from the active medium into the active medium, and the second optical system is arranged on an opposite side of the active medium and is adapted to reflect back radiation emitted from the active medium into the active medium, wherein a main plane of the first optical system extends perpendicular to the longitudinal axis of the active medium and is placed inside the active medium.

2. A laser system according to claim 1, wherein the main plane is placed in a distance of at least L/10, or at least L/5, or at least L/4, or at least L/3 of the side of the active medium at which the first optical system is arranged, or in the center of the active medium, wherein L is the extend of the active medium in the longitudinal direction.

3. A laser system according to claim 1, wherein the first optical system comprises a telescope and a planar mirror.

4. A laser system according to claim 3, wherein the telescope comprises a convex lens and concave lens, the convex lens being arranged closer to the active medium as the concave lens.

5. A laser system according to claim 1, wherein the second optical system comprises a parabolic mirror, or a spherical mirror, arranged and adapted to reflect back radiation emitted from the active medium back into the active medium.

6. A laser system according to claim 1, wherein the active medium comprises a Nd:YLF crystal rod or a Nd:YAG rod.

7. A laser system according to claim 1, wherein the total output power of the laser diodes is between 5000 W and 6000 W, preferably between 5200 W to 5600 W, most preferred 5400 W.

8. A laser system according to claim 1, wherein the laser system is adapted to generate pulses having a duration between 15 ns and 30 ns, preferably between 20 ns and 25 ns, the laser pulses having an energy of 150 mJ.

9. A laser system according to claim 1, wherein the laser system comprises a variable Q-switch that is adapted to have an adjustable switch point, wherein the time between switch points, corresponding to successive laser pulses, can be varied.

10. A laser system according to claim 1, wherein the first optical system is adapted to reflect back radiation emitted by the active medium into the active medium such that a percentage of the surface of the active medium, onto which the reflected radiation falls, is illuminated by the reflected radiation, wherein the percentage is at least 95%, preferably at least 98%, most preferred more than 99%.

11. A laser system according to claim 1, wherein the first optical system can be adjusted depending on the temperature of the active medium with respect to at least one optical property of the first optical system.

12. A method for generating laser pulses by using a laser system according to claim 1.

13. A method according to claim 12, wherein the time between switch points, corresponding to successive laser pulses, of the Q-switch is varied.

14. A method according to claim 12, wherein the duration of pumping phases during which the active medium is pumped is adjusted in accordance with a pulse generation frequency.

15. A method according to claim 12, wherein at least one property of the first optical system is adjusted depending on the temperature of the active medium, and wherein the location of the main plane of the first optical system within the active medium is changed.

16. A laser system comprising an active medium and at least one laser diode, or a plurality of laser diodes, that is/are adapted to pump the active medium, wherein the laser diode(s) is/are arranged such that a radiation plane of laser radiation emitted from the laser diode(s) and corresponding to the greatest emission angle a is/are essentially parallel or oblique to a longitudinal axis of the active medium.

17. A laser system according to claim 16, further comprising one or more blocks surrounding the active medium, wherein each of the blocks comprises a plurality of laser diodes, wherein each of the laser diodes is arranged such that the radiation plane of laser radiation emitted from the laser diode and corresponding to the greatest emission angle α is essentially parallel or oblique to the longitudinal axis of the active medium.

18. A laser system according to claim 17, wherein the laser diodes are arranged, in at least one block, with a distance d to each other and the block being arranged in a distance h from the active medium, wherein the distance h is given by
$$h \geq tan ( \frac{π}{2} - \frac{α}{2} ) \cdot \frac{d}{2} .$$

19. A laser system according to claim 17, wherein the laser diodes of each block are arranged on a straight line being parallel to the longitudinal axis of the active medium.

20. A laser system according to claim 17, wherein the blocks are arranged in an angular distance to each other, and wherein the angular distance of two adjacent blocks is
$$\frac{2 π}{n} ,$$
where n is the number of blocks.

21. A laser system according to claim 16, further comprising a reflector being arranged between the active medium and the laser diode and surrounding the active medium and comprising gap portions that are transparent for the radiation that can be emitted by the laser diode, wherein the reflector is formed such that radiation that can be emitted from the laser diode and can pass through the active medium via at least one of the gap portions can be reflected onto the active medium.

22. A laser system comprising an active medium and a reflector being arranged such that the reflector surrounds the active medium with at distance to the active medium characterized in that the reflector comprises a self-supporting cylinder consisting at least in part of a metal, e.g. copper.

23. A laser system according to claim 22, wherein the reflector further comprises a quartz-cylinder, and wherein the quartz-cylinder and the reflector are joint together and/or the quartz cylinder is inserted into the reflector.

24. A laser system according to claim 22, wherein the laser system further includes laser diodes being arranged outside of the reflector, and wherein the reflector comprises gap portions being transparent for laser radiation that is emitted from the laser diodes and that are arranged such that, when the laser diodes emit laser radiation, the laser radiation can incite, through the gap portions, onto the active medium.

25. A laser system according to claim 22, wherein the active medium has a cylindrical shape and the reflector is arranged concentrically around the active medium.

26. A method for pumping an active medium of a Q-switch laser system with a plurality of laser diodes, comprising:
pumping the active medium continuously during pumping periods of a predetermined duration, the pumping periods being provided periodically and being separated by non-pumping periods; and
during each pumping period, emitting at least two laser pulses from the active medium, wherein each of the at least two laser pulses is caused by a corresponding Q-switch operation in the pumping period.

27. A method according to claim 26, wherein each pumping period has a duration of more or less than 100 ps, or 200 ps, or 500 ps, or 1 ms, or 2 ms, or 5 ms and/or each non-pumping period has a duration of more or less than 1 ms, or 2 ms, or 5 ms, or 10 ms, or 20 ms, or 50 ms, or 100 ms.

28. A method according to claim 26, wherein the duration of the non-pumping period is equal to the duration of the pumping period or the duration of the non-pumping period is not equal to, in particular longer, such as e.g. at least 10 times longer than the duration of the pumping period.

29. A method according to claim 26, wherein power by which the active medium is pumped is at least 100 W, at least 500 W, or more than 1000 W.

30. A laser system comprising an active medium and a plurality of laser diodes, adapted to pump said active medium, wherein the laser system is adapted to operate according to the method according to claim 26.

31. A laser system according to claim 30, wherein the laser system is laser system according to claim 16.

32. A laser system comprising an active medium and a plurality of laser diodes, adapted to pump said active medium, wherein the laser system is a laser system according to claim 16.
